(19) United States
(12) Patent Application Publication
(10) Pub. No.: US 2014/0165573 A1
(43) Pub. Date: Jun. 19, 2014

(54) PROCESS FOR PRODUCING REFRACTORY CERAMICS FOR GAS TURBINE PLANTS

(71) Applicant: Claus Krusch, Mulheim an der Ruhr (DE)

(72) Inventor: Claus Krusch, Mulheim an der Ruhr (DE)

(73) Assignee: SIEMENS AKTIENGESELLSCHAFT, Müchen (DE)

(21) Appl. No.: 14/240,179

(22) PCT Filed: Aug. 14, 2012
(86) PCT No.: PCT/EP2012/065846

§ 371 Date: Feb. 21, 2014

(30) Foreign Application Priority Data
Aug. 31, 2011 (DE) 102011081847.2

(51) Int. Cl. B28B 1/087; B28B 1/14; B28B 11/24; F23R 3/00

(52) U.S. Cl. CPC B28B 1/087; F23R 3/002; B28B 1/14; B28B 11/243
USPC 60/753; 264/667

(57) ABSTRACT

A process for producing refractory ceramics (K) for use as heat shield in the hot gas path of gas turbine plants: introducing a casting composition into a component casing mold for the refractory ceramic (K), closing the casting mold so that the casting composition is under a defined static pressure after closure; orienting vibration of the casting mold in the direction (V) of a normal (N) to a surface of the refractory ceramic (K) to be produced, and subsequently removing the casting from the mold and firing the cast component.

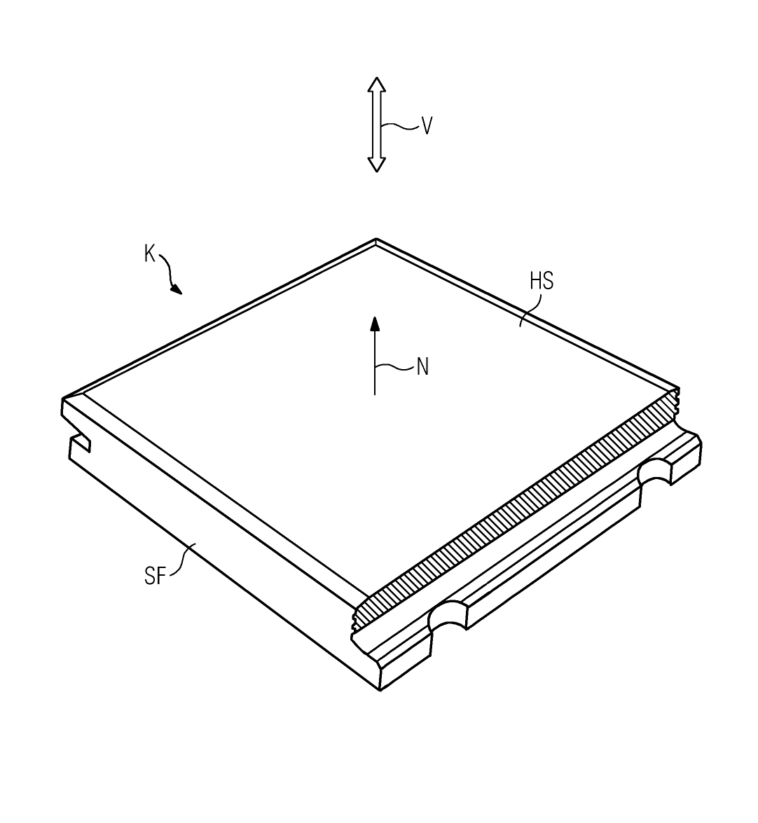

The invention relates to a process for producing refractory ceramics for use as a heat shield in the hot gas path of gas turbine plants according to the preamble of claim 1.

Gas turbine plants consist substantially of a compressor, a burner and an expansion turbine. In the compressor, aspirated air is compressed before it is mixed with fuel in a combustion chamber in the downstream burner arranged in the compressor plenum and this mixture is burned. The expansion turbine connected downstream of the combustion chamber then extracts thermal energy from the combustion exhaust gases produced and converts it into mechanical energy. A generator connected to the expansion turbine converts this mechanical energy further into electrical energy for power generation.

During the operation of the gas turbine plant, temperatures that are typically of the order of magnitude of about 1300 to 1500 degrees Celsius are produced in the combustion chamber, which forms the hot gas path between the burner and the gas turbine. Corresponding combustion chamber linings, for example in the form of heat shields, are therefore used for the thermal shielding of the components and supporting structures enclosing the hot gas path.

Such heat shields may in this case be made both of metals and of ceramics. In the case of gas turbine plants, ceramic materials, which are produced for example by means of a casting process, are preferred on account of the aggressive hot gases. However, air pockets may occur in the casting composition in the course of the casting process and may lead to defects (voids) in the green body or in the finished, fired component. These defects occur both in the volume and on the surface of the refractory ceramics. Surface defects, however, especially on the hot gas side of the refractory ceramic, represent the main criterion for rejection during quality control, since they particularly influence the mechanical properties. The voids may cause weakening of the mechanical structures, and consequently increased crack formation in the refractory ceramic.

The object of the invention is to provide a process that avoids this disadvantage.

This object is achieved by the process of claim 1, which comprises the following steps:
filling of a component casting mold for a refractory ceramic with a casting composition,
closing of the casting mold, so that the casting composition is under a defined static pressure after closing,
directional vibration of the casting mold in the direction (V) of a normal (N) to a surface of the refractory ceramic to be produced that has to meet particular quality requirements for use as a heat shield,
and subsequent demolding and firing of the cast component.

The directional vibration of the casting composition in the direction of the normal to the component surfaces that are critical with respect to quality after it has been introduced into the casting mold and while maintaining a defined static pressure allows an almost void-free surface to be achieved.

Weakening of the ceramic heat shield, in particular of the most highly stressed hot gas side, as a result of strength-reducing defects is thus effectively prevented.

If further surfaces of the refractory ceramic have similar quality characteristics, the step of vibrating in the direction of the normal to the surfaces must be correspondingly repeated in each case.

A heat shield consisting of at least one refractory ceramic that is produced by the process according to the invention is in this case particularly robust and a gas turbine plant equipped with such a heat shield can be safely operated.

The invention is now to be explained by way of example on the basis of the refractory ceramic K represented in the figure. The process of casting this refractory ceramic involves the use of a casting mold cover (not shown any more specifically), which when placed onto the casting mold shell penetrates into the casting composition located therein and, during closing of the cover, increasingly subjects the casting composition to a previously fixed static pressure until the casting mold is closed. With a given geometry of the cover, the filling level of the casting composition represents the main process parameter that determines the degree of displacement of the composition, and consequently the resultant static pressure. Preferably, even the placement of the casting mold cover may take place under vibration. For secure closing of the casting mold, the casting mold should then be provided with a clamping device, with which high clamping forces can be produced. Such a clamping device is represented for example by toggle clamps. Preferably, the geometry of the casting mold closure already corresponds to the actual geometry of the refractory ceramic K to be produced, so that reworking of the component surfaces can be avoided entirely and the grinding of any sprues there may be can be greatly reduced.

The closed casting mold under static pressure is subsequently subjected to directional vibration. The distribution of the surface and volume defects (voids) in the component K can be controlled by the direction of vibration or force introduction V, which is determined by the position of the casting mold in relation to the direction of vibration. The direction of force introduction V should be chosen here such that it acts in the direction of the normal N to the surface of the component that is critical with respect to quality—here the hot gas side HS of the refractory ceramic. In this way, a virtually void-free surface of the hot gas side HS of the refractory ceramic for gas turbine plants can be achieved here.

If further surfaces—for example the side surfaces SF—are to meet quality requirements similar to those for the previously described hot gas side HS, the directional vibration must be repeated in the same way for these surfaces. The casting mold is then subsequently vibrated directionally for each of the surfaces of the component that are critical with respect to quality in succession, in each case in a direction normal to the surface.

The main process parameters for the directional vibration are the direction, time, frequency and amplitude of the vibration and also the static pressure produced by the mold closure. Altogether, the following advantages are consequently obtained by the process according to the invention:
reduction in rejections as a result of avoidance of voids or significant reduction of the frequency of voids on the heat shield surfaces;
increase in the passive safety of the ceramic heat shields by reducing the number and size of defects;
reproducibility of the production process is improved considerably;
automatability of the production process;
reduction of unit costs.

1. A process for producing refractory ceramics for use as a heat shield in the hot gas path of gas turbine plants, comprising the steps of:
filling a component casting mold for the refractory ceramic with a casting composition;
closing the casting mold, so that the casting composition is under a defined static pressure after closing; and
directionally vibrating the closed casting mold in a direction (V) of a normal (N) to a surface of the refractory ceramic to be produced in the mold so that the ceramic component meets particular quality requirements for use as a heat shield; and
subsequently demolding and then firing of the cast component.

2. The process as claimed in claim 1, further comprising providing a casting composition such that after being produced the surface of the refractory ceramic that meets the particular quality requirements is the hot gas side (HS) of the cast component of the refractory ceramic (K).

3. The process as claimed in claim further comprising:
repeating the step of directionally vibrating in a respective vibration direction selected for each of further surfaces of the refractory ceramic to be produced.

4. A heat shield for a gas turbine plant, comprised of at least one refractory ceramic that is produced by the process as claimed in claim 1.
